(19) United States
(12) Patent Application Publication
(10) Pub. No.: US 2023/0193154 A1
(43) Pub. Date: Jun. 22, 2023

(54) SOLID COMPOSITION

(71) Applicant: RECKITT BENCKISER FINISH B.V., Hoofddorp (NL)

(72) Inventors: Souhila AISSANI, Heidelberg (DE); Natalia FRAGOSO, Heidelberg (DE); Patrick ILLERT, Heidelberg (DE); Torsten ROTH, Heidelberg (DE); Pavlinka ROY, Heidelberg (DE); Itahisa SUAREZ, Heidelberg (DE); Helena BAIERLE, Heidelberg (DE); William WHITTAKER, Heidelberg (DE)

(21) Appl. No.: 17/998,263

(22) PCT Filed: May 12, 2021
(86) PCT No.: PCT/EP2021/062652

§ 371 Date: Nov. 9, 2022

(30) Foreign Application Priority Data
May 14, 2020 (GB) 2007128.8

(51) Int. Cl. C11D 1/52; C11D 3/02; C11D 3/50; C11D 17/04; C11D 17/00

(52) U.S. Cl. CPC C11D 1/52; C11D 3/02; C11D 3/50; C11D 17/044; C11D 17/0091

(57) ABSTRACT

The present invention relates to a solid composition comprising a matrix and one or more actives, said matrix comprising steramide or poly(vinyl alcohol) having a melting point higher than 150° C. It also relates to a cage and to a product comprising said solid composition and said cage, wherein said solid composition is contained in said cage. It further relates to a product comprising said solid composition and a porous solid support, wherein said solid composition is attached to said porous solid support. It further relates to a method for the controlled release of one or more actives in an automatic washing operation by providing said solid composition or any of the products to the machine in which said automatic washing operation is performed.

The present invention relates to a solid composition comprising a matrix and one or more actives. It also relates to a cage and to a product comprising said solid composition and said cage, wherein said solid composition is contained in said cage. It also relates to a product comprising said solid composition and a porous solid support, wherein said solid composition is attached to said porous solid support. The invention further relates to a method for the controlled release of one or more actives in an automatic washing operation.

### BACKGROUND

Currently, the vast majority of automatic washing products, for example automatic dishwashing products or automatic laundry products, are single-dose products that the consumer must dose each time that they would like to experience the benefit offered by different products, examples include, mono-dose detergents, detergent gels, machine cleaners, and boosters. There are a few exceptions that provide consumers with a benefit over multiple cycles, such as conventional liquid rinse aids and dishwasher deodorants or fresheners. In cases where the consumer benefit is delivered over multiple cycles, there is only a limited range of actives that can be delivered over multiple cycles, and often these product formats do not give consumers a clear end of life indication. For example, conventional rinse aids are commonly found in the market as bottled liquids that must be used periodically to fill the designated rinse aid dispenser found inside the dishwasher. However, this task can be quite tedious for consumers as it is often difficult for consumers to know when the rinse aid reservoir needs to be replenished. The main reason for this is that automatic dishwashing machines often lack a clear visual indication to the consumer that there is a need to refill the rinse aid dispenser in the machine.

Considering automatic washing machines, such as automatic dishwashing machines and automatic laundry machines, actives to achieve a consumer benefit are normally provided as single-dose products, for example, bleach booster, cleaning performance booster, shine performance improver, material care product, antimicrobial agents, and malodour control agent.

A rinse aid in a solid format would solve the aforementioned issues linked to conveying to the consumer the need of refilling the rinse aid dispenser. This is due to the fact that the solid matrix that makes up the rinse aid is a visible solid and it allows the consumer to see the product at different stages of its lifespan, and most importantly to discern when the product is used up and must be replaced.

Therefore, there is a need of a solid composition comprising one or more actives to achieve a consumer benefit that can be used during several washing cycles. This means that the solid composition must provide a controlled release of said one or more actives.

Furthermore, there is a need of a solid composition comprising one or more actives to achieve a consumer benefit capable of providing a control release of said one or more actives, said solid composition being usable during several washing cycles and providing a clear end-of-life indication to the consumer.

### SUMMARY OF THE INVENTION

The present invention provides a solid composition comprising one or more actives to achieve a consumer benefit that can be used during several washing cycles and preferably, the solid composition also provides a clear end-of-life indication. This is achieved by:
a. providing a solid composition comprising a matrix and one or more actives, and/or
b. providing a perforated cage in which a solid composition is contained and in which parameters such as:
   the ratio of open to closed area of the perforated cage, and/or
   the water throughout the perforations per unit open area, and/or
   the diameter and/or number of the perforations are controlled.

The solid composition comprising a matrix and one or more actives may be presented as a powder, as a compressed powder, as a gel, as an aggregation of solids, as a continuous solid, as a non-homogeneous solid. It will be understood that by solid, it is meant a solid at room temperature, for example at temperatures lower than 50° C., preferably lower than 40° C., more preferably lower than 30° C., even more preferably lower than 25° C.

In a first aspect, the present invention relates to a solid composition comprising a matrix and one or more actives, said matrix comprising a fatty acid amide having a melting point higher than 85° C. or a water-soluble synthetic polymer having a melting point higher than 150° C.

The fatty acid amide is stearamide.

In one embodiment, said composition comprises between 1 wt. % and 50 wt. % of said stearamide, based on the total weight of the composition, preferably between 5 wt. % and 40 wt. %, more preferably between 5 wt. % and 30 wt. %.

The water-soluble synthetic polymer having a melting point higher than 150° C. is poly(vinyl alcohol).

In an embodiment, said composition comprises between 1 wt. % and 70 wt. % of said water-soluble synthetic polymer having a melting point higher than 150° C., based on the total weight of the composition, preferably between 5 wt. % and 60 wt. %, more preferably between 10 wt. % and 50 wt. %.

The matrix further comprises a hardening agent, which is polyethylene glycol having a melting point between 40° C. and 70° C.

The composition comprises between 10 wt. % and 50 wt. % of polyethylene glycol having a melting point between 40° C. and 70° C., based on the total weight of the composition.

In an embodiment, said matrix further comprises at least one hydrocarbon compound having a melting point lower than 90° C. selected from the group consisting of non-glyceride long-chain (C24-C34) carboxylic acid esters, free long-chain organic acids, long-chain alcohols, (Z)-docos-13-enamide, and combinations thereof.

The composition may comprise between 1 wt. % and 50 wt. % of said hydrocarbon compound having a melting point lower than 90° C., based on the total weight of the composition, preferably between 1 wt. % and 30 wt. %, more preferably between 1 wt. % and 20 wt. %.

In an embodiment said one or more actives comprise at least one non-ionic surfactant having a melting point higher than 20° C., preferably at least one modified polyglycol ether having a melting point higher than 20° C.

In another embodiment, said one or more actives comprise at least one non-ionic surfactant having a melting lower than 20° C., preferably at least one alkoxylated alcohol having a melting point lower than 20° C. and described by the formula R³[CH₂CH₂O]_{w}OH; wherein: R³ represents a linear or branched chain aliphatic hydrocarbon group with 10-18 carbon atoms or mixtures thereof, preferably with 12-16 carbon atoms or mixtures thereof; and w has a value between 1 and 10, preferably between 3 and 9, more preferably between 5 and 8, even more preferably 7 or 8, most preferably 8.

In another embodiment, said one or more actives comprise at least one non-ionic surfactant having a melting point higher than 20° C., preferably at least one modified polyglycol ether having a melting point higher than 20° C. and at least one non-ionic surfactant having a melting lower than 20° C., preferably at least one alkoxylated alcohol having a melting point lower than 20° C. and described by the formula R³[CH₂CH₂O]_{w}OH; wherein: R³ represents a linear or branched chain aliphatic hydrocarbon group with 10-18 carbon atoms or mixtures thereof, preferably with 12-16 carbon atoms or mixtures thereof; and w has a value between 1 and 10, preferably between 3 and 9, more preferably between 5 and 8, even more preferably 7 or 8, most preferably 8.

In an embodiment, said one or more actives comprise at least one oxidation catalyst, preferably selected from the group consisting of manganese salts, manganese proteinates, cobalt-amine catalysts, bis (N,N′,N″- trimethyl 1,4,7-triazacyclononane)-tri-(μ-oxo)-dimanganese (IV) di(hexafluorophosphate)monohydrate (MnTACN) catalyst, and combinations thereof.

In an embodiment, said one or more actives comprise one or more enzymes and/or one or more builders.

In another embodiment, said one or more actives comprise one or more anti-corrosion agents.

In another embodiment, said one or more actives comprise one or more additives with antimicrobial activity selected from the groups consisting of preservatives, antimicrobial bleaching agents, probiotic bacteria, metal and metal-oxide nanoparticles, and combinations thereof.

In another embodiment, said one or more additives comprise at least one fragrance.

Said composition may comprise between 1 wt. % and 70 wt. % of said one or more actives, based on the total weight of the composition, preferably between 1 wt. % and 60 wt. %, more preferably between 1 wt. % and 50 wt. %, even more preferably between 1 wt. % and 45 wt. %.

In an embodiment, said composition is an automatic dishwashing composition.

In a second aspect, the invention relates to a cage for the release of a composition comprising one or more actives, said cage comprising at least one side with perforations, wherein in said at least one side with perforations the ratio of the total area of the apertures or perforations to the total area without apertures or perforations of said at least one side with apertures or perforations, Aₒₚₑₙ:A_{closed}, is less than 3:1.

In an embodiment said cage has a liquid throughput per unit open area that is less than 1 mL/(min×cm²), preferably less than 0.5 mL/(min×cm²), more preferably less 0.4 mL/(min×cm²).

In a third aspect, the invention relates to a product comprising the solid composition according to the first aspect and the cage according to the second aspect, wherein said solid composition is contained in said cage

In a fourth aspect, the invention relates to a product comprising the solid composition according to the first aspect and a porous solid support, wherein said solid composition is attached to said porous solid support.

In a fifth aspect, the invention relates to a method for the controlled release of one or more actives in an automatic washing operation by providing a composition according to the first aspect or a product according to the third aspect or a product according to the fourth aspect to the machine in which said automatic washing operation is performed.

In an embodiment, said automatic washing operation is an automatic dishwashing operation or a laundry washing operation, preferably an automatic dishwashing operation.

Definitions

The following definitions are used in the present application.

“Active”, as used in the present patent application means, a material, ingredient, compound or product that provides a consumer benefit, for example, rinse aids, bleach booster, cleaning performance booster, shine performance improver, material care product, antimicrobial agents, and malodour control agent. The active can be used alone or in combination with an automatic washing detergent, for example, together with an automatic dishwashing detergent.

“Drying index” or “DI”, as used in the present application means, indication of the drying performance of a formulation in a dishwashing cycle. It ranges from 0 to 1, where 0 indicates completely wet dishes and 1 indicates fully dry dishes. It is calculated according to the following equation:

$$DI = \frac{Σ S}{2 \times N} \qquad Eq . ( 1 )$$

In Eq. (1), S represents the score and N is the total number of items.

The drying index is determined by running a dishwashing cycle three times. After three cycles, the arithmetic average and the standard deviation of the drying indices are calculated. If the standard deviation is higher than 0.10 a further test cycle is recommended, and the anomalous run is excluded.

“Score” or “S”, as used in the present patent application means, number giving to an item after this has been washed and dry. This is determined visually, and each item is observed for a maximum of 8 seconds. A score of 2 is given to a dry item, i.e. completely free of moisture. A score of 1 is given to an item that is not completely dry, i.e. one or two drops of water, or one wet streak and when the total wet area is less than 50 mm². A score of 0 is given to an item that is wet, i.e. more than two drops of water, or one drop and one streak, or two streaks, or water in glass or cup cavity, and when the total wet area is more than 50 mm².

“End-of-life indication”, as used in the present patent application means, method used for determining the end-of-life of a composition. This can be determined calculating the “remaining area” or “% RA” of a composition or by weighing a composition before and after performing a test.

The “remaining area” or “RA” of a solid composition is given by dividing the length of the composition in a determined direction before performing a test by the length of the composition in the same direction after a certain period, normally the end of the test. For example, if the length of a solid composition before performing a test is 5 cm and the length of the composition at the end of the test in the same direction is 3 cm, then % RA=100×3/5=60%.

“Bleach score”, as used in the present patent application means, evaluation of bleaching performance considering the protocol of the German Cosmetic, Toiletry, Perfume and Detergent Association (IKW). This is done by visual comparison to a reference photographic catalogue, as mentioned in the “Recommendations for the Quality Assessment of the Cleaning Performance of Dishwasher Detergent (Part B, Update 2015)”—Instructions for Preparation—Test Soil Types—Test Procedures, sofwjournal, 142, 06/16. The bleach score ranges from 1 until 10. A bleach score of 10 is given to an item with no signs of stains and a bleach score of 1 is given to an item from which almost no stain is removed. As previously mentioned, all scores are given by comparing the test item with a reference photographic catalogue.

“Shine performance”, as used in the present patent application means, scoring system for evaluating the shine performance of a product in an automatic washing operation, for example an automatic dishwashing operation. A shine performance of 5 means extremely strong spotting or filming. A shine performance of 4 means very strong spotting or filming. A shine performance of 3 means strong spotting or filming A shine performance of 2 means slightly spotting or filming. A shine performance of 1 means no spotting or filming. Shine performance is determined after 5 washing cycles and after 20 washing cycles.

“Porous solid support”, as used in the present patent application means, support on which a formulation or composition is deposited or applied. It will be understood that a solid porous solid support is not a cage but just a substrate on which the formulation is applied or deposited.

### DETAILED DESCRIPTION

In a first aspect the present invention relates to a solid composition comprising a matrix and one or more actives, said matrix comprising a fatty acid amide having a melting point higher than 85° C. or a water-soluble synthetic polymer having a melting point higher than 150° C.

The fatty acid amide has a melting point higher than 100° C. and is stearamide, i.e. Octadecanamide. Stearamide has a melting point of about 108° C. and is highly hydrophobic; however, it can be mixed with several actives and these actives can then be controllably released during machine washing operations.

The person skilled in the art will understand that a fatty acid amide is an amide formed from a fatty acid and an amine. In the fatty acid, the hydroxyl group is replaced by an amine group.

The composition may comprise between 1 wt. % and 50 wt. % of said stearamide, based on the total weight of the composition. Preferably, the composition comprises between 5 wt. % 40 wt. % of said fatty acid amide having a melting point higher than 85° C., more preferably between 5 wt. % and 30 wt. %.

The water-soluble synthetic polymer having a melting point higher than 150° C. is poly(vinyl alcohol).

The composition may comprise between 1 wt. % and 70 wt. % of poly(vinyl alcohol) having a melting point higher than 150° C., based on the total weight of the composition, preferably between 5 wt. % and 60 wt. %, more preferably between 10 wt. % and 50 wt. %.

The composition further comprises a hardening agent, which aids solidify the solid composition. The hardening agent is polyethylene glycol having a melting point between 40° C. and 70° C.

The composition comprises between 10 wt. % and 50 wt. % of said hardening agent, based on the total weight of the composition.

The present inventors have observed that polyethylene glycol provides a stable composition with a well-controlled release of actives.

The invention then relates to a solid composition comprising a matrix and one or more actives, said matrix comprising:
stearamide or poly(vinyl alcohol) having a melting point higher than 150° C.; and
between 10 wt. % and 50 wt. % of polyethylene glycol having a melting point between 40° C. and 70° C., based on the total weight of the composition.

However, a composition with a matrix comprising stearamide, might not show a clear end-of-life indication. This problem is solved by adding at least one hydrocarbon compound having a melting point lower than 90° C. to the composition. The at least one hydrocarbon compound is selected from the group consisting of non-glyceride long-chain (C24-C34) carboxylic acid esters, free long-chain organic acids, long-chain alcohols, (Z)-docos-13-enamide, and combinations thereof. An example of a hydrocarbon compound comprising non-glyceride long-chain (C24-C34) carboxylic acid esters is Licowax™ KLE, which is a mixture of waxes of montan acid esters. An example of a hydrocarbon compound comprising (Z)-docos-13-enamide is Crodamide® ER MB-(GD).

The present inventors have observed, that, for example, in an automatic dishwashing (ADVV) machine, compositions comprising stearamide and a hydrocarbon compound having a melting point lower than 90° C., e.g. waxes of montan esters and/or (Z)-docos-13-enamide, provide a clear end-of-life indication.

In a preferred embodiment, the matrix comprises at least one hydrocarbon compound having a melting point lower than 90° C. comprising non-glyceride long-chain (C24-C34) carboxylic acid esters and/or (Z)-docos-13-enamide.

The composition may comprise between 1 wt. % and 50 wt. % of said hydrocarbon compound having a melting point lower than 90° C., based on the total weight of the composition. Preferably, the composition comprises between 1 wt. % and 30 wt. % of said hydrocarbon compound having a melting point lower than 90° C., more preferably between 1 wt. % and 20 wt. %.

The said one or more actives of the composition provide a consumer benefit. The composition may comprise between 1 wt. % and 70wt. % of said one or more actives, based on the total weight of the composition. Preferably, the composition comprises between 1 wt. % and 60 wt. % of said one or more actives, more preferably between 1 wt. % and 50 wt. %, even more preferably between 1 wt. % and 45 wt. %. Preferably the composition comprises at least 10 wt. % of said one or more actives.

For example, said one or more actives may comprise at least one non-ionic surfactant having a melting point higher than 20° C., preferably at least one modified polyglycol ether having a melting point of higher than 20° C. Without wishing to be bound to any theory, the present inventors believe that this type of non-ionic surfactants exhibits poor dispersion in the wash broth, causing them to remain at the bottom of the dishwasher at the end of the wash cycle and to be carried over to the rinse cycle where they will effectively improve the drying. Furthermore, they are waxy surfactants that are in the solid state at room temperature, which was deemed beneficial as it would allow the actives in the matrix to be released gradually throughout the product's lifespan, as opposed to being predominantly released in the first few cycles of product use. These non-ionic surfactants are rinse aids and they provide an improved drying, anti-spotting and shine-properties on hard surfaces treated with a composition comprising them. Hard surfaces can be, for example, kitchenware, walls and floors.

Preferred examples of modified polyglycol ethers are those described by the formula:

R¹O[CH₂CH(CH₃)O]ₓ[CH₂CH₂O]_{y}[CH₂CH(OH)R²]

wherein:
R¹ represents a linear or branched chain aliphatic hydrocarbon group with 6-16 carbon atoms or mixtures thereof,
R² represents a linear or branched chain aliphatic hydrocarbon rest with 6-16 carbon atoms or mixtures thereof,
x has a value between 0 and 5, preferably x is 0 and
y has a value between 15 to 40, preferably between 18 to 25.

Preferably x is 0 and y has a value between 18 to 25.

It will be understood by the person skilled in the art that these preferred examples of modified polyglycol ethers would have a melting point higher than 20° C., i.e. they are solid at room temperature.

Examples of modified polyglycol ethers having a melting point higher than 20° C. and being particularly preferred are Genapol™ EC50 and Dehypon™ E127.

The composition may comprise between 1 wt. % and 60 wt. % of said at least one non-ionic surfactant having a melting point higher than 20° C., based on the total weight of the composition, preferably between 5 wt. % and 50 wt. %, wherein preferably said at least one non-ionic surfactant having a melting point higher than 20° C. comprises of consists of at least one modified polyglycol ether having a melting point of higher than 20° C.

Said one or more actives may comprise at least one non-ionic surfactant having a melting lower than 20° C., preferably at least one alkoxylated alcohol having a melting point lower than 20° C. and described by the formula:

R³[CH₂CH₂O]_{w}OH

wherein:
R³ represents a linear or branched chain aliphatic hydrocarbon group with 10-18 carbon atoms or mixtures thereof, preferably with 12-16 carbon atoms or mixtures thereof, and
w has a value between 1 and 10, preferably between 3 and 9, more preferably between 5 and 8, even more preferably 7 or 8, most preferably 8.

It will be understood by the person skilled in the art that these preferred examples of alkoxylated alcohols are ethoxylated alcohols and these would have a melting point lower than 20° C., i.e. they are liquid at room temperature.

Examples of ethoxylated alcohols having a melting point lower than 20° C. and being particularly preferred are those of the Lutensol™ series.

The present inventors have observed that ethoxylated alcohols having 7 ethylene oxide units have a surprisingly good performance, considering for example, rinse aid properties. A particularly preferred example of such ethoxylated alcohols is Lutensol™ TO7.

The composition may comprise between 1 wt. % and 50 wt. % of said at least one non-ionic surfactant having a melting lower than 20° C., based on the total weight of the composition, preferably between 5 wt. % and 40 wt. %, wherein preferably said at least one non-ionic surfactant having a melting point lower than 20° C. comprises or consists of at least one alkoxylated alcohol having a melting point lower than 20° C.

Preferably said one or more actives comprise at least one non-ionic surfactant having a melting point higher than 20° C., preferably at least one modified polyglycol ether having a melting point higher than 20° C., and at least one non-ionic surfactant having a melting lower than 20° C., preferably at least one alkoxylated alcohol having a melting point lower than 20° C. and described by the formula R³[CH₂CH₂O]_{w}OH; wherein: R³ represents a linear or branched chain aliphatic hydrocarbon group with 10-18 carbon atoms or mixtures thereof, preferably with 12-16 carbon atoms or mixtures thereof; and w has a value between 1 and 10, preferably between 3 and 9, more preferably between 5 and 8, even more preferably 7 or 8, most preferably 8. This combination of non-ionic surfactants provides further improved drying, anti-spotting and shine performance than when only one of the above-mentioned at least one non-ionic surfactants is used.

Without wishing to be bound to any theory, the present inventors believe that polyglycol ethers, such as e.g. Genapol™ EC50 and Dehypon™ E127, are emulsifiable rather than soluble in water. By adding an alkoxylated alcohol, e.g. Lutensol™ TO7, to a formulation comprising one or more modified polyglycol ethers, e.g. Genapol EC50, the dispersion of the polyglycol ether in the washing liquor is increased, which leads to an improved performance of the formulation.

Said one or more actives may comprise an oxidation catalyst, preferably selected from the group consisting of manganese salts, e.g. manganese oxalate, manganese-acetate, etc, manganese-proteinates, cobalt-amine catalysts, Bis(N,N′,N″-trimethyl 1,4,7-triazacyclononane)-tri-(μ-oxo)-dimanganese (IV) di(hexafluorophosphate)monohydrate (MnTACN) catalyst, and combinations thereof. The oxidation catalysts may comprise other metal compounds, such as iron or cobalt complexes.

Said one or more actives may comprise one or more enzymes and/or one or more builders, which provide an improved cleaning performance than when only an automatic washing detergent is used.

The builders may be selected from the group consisting of sodium tripolyphosphate (STPP), sodium citrate, sodium iminodisuccinate, sodium hydroxyiminodisuccinate, methylglycine diacetic acid sodium salt (MGDA), and glutamic diacetic acid sodium salt (GLDA), and combinations thereof. However, the invention is not limited to these builders.

The enzymes may be selected from the group consisting of proteases, lipases, amylases, cellulases, pectinases, laccases, catalases, oxidases, and combinations thereof. Any suitable species of these enzymes may be used as desired.

Said one or more actives may comprise one or more anti-corrosion agents. Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C1-C20 alkyl groups and hydroxyl, thio, phenyl or halogen such as fluorine, chlorine, bromine and iodine. A preferred substituted benzotriazole is tolyltriazole.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂ and Ce(NO₃)₃. Any suitable source of multivalent ions may be used, with the source preferably being chosen from sulphates, carbonates, acetates, gluconates and metal-protein compounds. Zinc salts are specially preferred glass corrosion inhibitors.

In particular for the protection of non-metallic inorganic items, such as glassware, ceramic and enamel materials, said one or more anti-corrosion agents are selected from the group of polymers having quaternary ammonium centres known as polyquaterniums, preferably polyquaternium-2 or Urea, N,N′-bis(3-(dimethylamino)propyl)-, polymer with 1,1′-oxybis(2-chloroethane). Polyquaternium-2 has a permanent positive charge independently of the pH of the solution in which it can be present. It protects non- metallic inorganic items as mentioned before by adhering to their surfaces. An example of a compound comprising Polyquaternium-2 is Lugalvan® P.

Said one or more actives may comprise one or more additives with antimicrobial activity selected from the groups consisting of preservatives, antimicrobial bleaching agents, probiotic bacteria, metal and metal-oxide nanoparticles, and combinations thereof.

Considering an automatic washing machine, such as an automatic dishwasher machine, which primary function is to remove food residues from dishware, a number of secondary benefits are also valued by the consumer. As an example, it is common practice to place infant's feeding items in the dishwasher to help prevent contamination due to germs. The combination of high wash temperatures, strongly oxidizing bleaching agents and enzymes in ADW detergents is thus an established method to reduce growth of viruses, bacteria, parasites and fungi stemming from the outside environment. However, not all formulations and product formats available on the market today provide full protection and the desired sanitization benefits that the consumer is expecting. Therefore, formulations lacking a comprehensive bleach system (e.g. ADW detergent gels) and/or appropriate dishwasher operating conditions (e.g. short, low temperature wash cycles) may result in inadequate hygienic conditions in the machine.

A composition according to the present invention further comprising one or more additives with antimicrobial activity selected from the group consisting of preservatives, antimicrobial bleaching agents, probiotic bacteria, metal and metal-oxide nanoparticles, and combinations thereof, leads to an improvement of the hygienic conditions in an automatic washing machine, preferably an automatic dishwashing machine.

The preservatives may be selected from the group consisting of antimicrobials used to control bacterial, algae and fungi in household consumer products based on isothiazolinone

The antimicrobial bleaching agents are known to display a strong anti-microbial profile. These antimicrobial bleaching agents may be selected from the group consisting of peracid precursor compounds, stable peracids, and combinations thereof. For example, peracetic acid generated in situ from TAED and hydrogen peroxide is a potent source of antimicrobial efficacy. Examples of peracid precursor compounds are tetracetyl ethylene diamine (TAED), sodium 3,5,5 trimethyl hexanoyloxybenzene, sulphonate, diperoxy dodecanoic acid, nonylamide of peroxyadipic acid, n-nonanoyloxybenzenesulphonate (NOBS), and dodecanoyl oxybenzene sulphonate (DOBS).

Examples of a stable peracids are perbenzoic acid and peroxycarboxylic acids.

Furthermore, selected probiotics display an observable activity over a range of pathogenic, carcinogenic and conditionally pathogenic microorganisms. In addition, probiotic bacteria in their spore form are well-known to be stable in harsh environments.

With other words, selected probiotics would be stable in harsh environments, whilst also exhibiting antimicrobial activity in an automatic washing operation, for example, an automatic dishwashing operation or an automatic laundry operation.

Examples of probiotics are probiotic selected from Bacillus megaterium, Bacillus amyloliqueiaciens, Bacillus subtillis, and Bacillus pumilus.

Several metal species are known to exhibit a long-term antibacterial and biofilm prevention properties. Due to their catalytic mode of action—bactericidal properties arise through the generation of reactive oxygen species—an inclusion of metal and/or metal-oxide nanoparticles in a slow-dissolving matrix is possible, as well as an immobilization in or on the surface of the cage or container.

Said one or more actives may comprise at least one fragrance for controlling malodour.

Preferably, the composition is an automatic dishwashing composition.

It will be understood that the composition according to the invention can be used during several washing and/or rinsing cycles, for example at least 5 washing or rising cycles or at least 10 washing or/rinsing cycles or at least 15 washing or rinsing cycles or at least 20 washing or rinsing cycles or at least 25 washing or rinsing cycles.

In a preferred embodiment, the composition is a solid rinse aid composition, wherein said composition can be used for at least 5 washing or rising cycles or at least 10 washing or/rinsing cycles or at least 15 washing or rinsing cycles or at least 20 washing or rinsing cycles or at least 25 washing or rinsing cycles. Said solid rinse aid composition providing improved drying performance and/or corrosion protection of non-metallic solid surfaces.

It should be noted that formulations according to the first aspect of the invention comply with the REACH regulation of the EU. REACH is the acronym for Registration, Evaluation, Authorisation and Restriction of Chemicals. This regulation was proposed for the protection of human health and protection of the environment. Therefore, it forces the use of potentially toxic substances to be phased out.

In a second aspect, the present invention relates to a cage for the release of a composition comprising one or more actives, said cage comprising at least one side with perforations, wherein in said at least one side with perforations the ratio of the total area of the apertures or perforations (Aₒₚₑₙ) to the total area without apertures or perforations (A_{closed}) of said at least one side with apertures or perforations, i.e. Aₒₚₑₙ:A_{closed}, is less than 3:1.

Preferably in said at least one side with perforations Aₒₚₑₙ:A_{closed}, is less than 2:1, more preferably less than 1.8:1.

The ratio Aₒₚₑₙ:A_{closed} is directly related to the liquid throughput per unit open area that the cage allows. Considering automatic washing operations, this liquid is water, and the liquid throughput per unit open area may be less than 1 mL/(min×cm²), preferably less than 0.5 mL/(min×cm²), even more preferably less 0.4 mL/(min×cm²).

The perforations of said at least one side with perforations may have a circular shape, a rectangular shape, elliptical shape, triangular shape, polyhedral shape, and combinations thereof, preferably the perforations have a circular shape.

In an embodiment the perforations of said at least one side with perforations have a circular shape with a diameter of between 0.1 cm and 5 cm, preferably between 0.25 cm and 4 cm, more preferably between 0.5 cm and 3 cm, even more preferably between 0.5 cm and 2 cm.

For example, said cage may have at least one side with perforations and all other sides without perforations, in which case it is possible to separate two or more sides of the cage to fill it in with a composition comprising one or more actives.

The present inventors have observed that by controlling parameters such as Aₒₚₑₙ:A_{closed} and/or the liquid throughput per unit open area in the cage according to the second aspect, this cage allows for the controlled release of a composition, for example, in an automatic washing machine, preferably an automatic dishwashing machine.

In an embodiment the cage is made of a solid material that is insoluble in water. For example, a polymer, a metal, a biopolymer such as hard-pressed plant fibres, a ceramic material or glasses. Preferably the cage is made of plastic.

The cage according to the second aspect can be used in an automatic washing machine, for example an automatic dishwashing machine, for the controlled release of a composition comprising one or more actives.

In a third aspect, the present invention relates to a product comprising the solid composition according to the first aspect and a cage according to the second aspect, wherein said composition is contained in said cage.

The present inventors have observed that optimum controlled release of the solid composition according to the first aspect can be obtained when Aₒₚₑₙ:A_{closed} is less than approximately 1.80:1 and/or when the liquid throughput per unit open area is less than approximately 0.40 mL/(min×cm²).

It will be understood that the composition is preferably in the form of a continuous solid or a gel and that it will fill the whole internal volume of the cage.

In a fourth aspect, the present invention relates to a product comprising the solid composition according to the first aspect and a porous solid support, wherein said solid composition is attached to said porous solid support.

In an embodiment the porous solid support has a mesh with an average pore size of between 0.5 mm and 5 mm, preferably between 1 mm and 2.5 mm, more preferably between 1 mm and 2 mm.

In a fifth aspect, the present invention relates to a method for the controlled release of one or more actives in an automatic washing operation by providing a composition according to the first aspect or a product according to the third aspect or to the fourth aspect to the machine in which said automatic washing operation is performed.

Preferably said automatic washing operation is an automatic dishwashing operation or a laundry washing operation, more preferably an automatic dishwashing operation.

The invention will be further described with the reference to the following non-limiting examples.

### EXAMPLES

Formulations

Four formulations were prepared in order to determine their ability to deliver an end-of-life indication. These formulations, as shown in Table 1, were prepared by mixing the ingredients at a temperature of between 60° C. and 100° C. to obtain a flowable mixture and pouring the mixture into a plastic cage and allow it to solidify at a temperature of about 20° C.

The cage had one side without apertures and one side with circular apertures, so that for the side with apertures, the total open surface area was 26.21 cm² and the total area without apertures was 41.1 cm². Thanks to the apertures in the cage it was possible to observe the end-of-life of the formulations.

TABLE 1
Formulations with a matrix comprising a fatty acid amide
having a melting point higher than 85° C.

| | Formulations (wt. %) | | | |
|---|---|---|---|---|
| Ingredient | F1 | F2 | F3 | F4 |
| Polyethylene glycol with melting point | 40-45 | 40-45 | 40-45 | 40-45 |
| 55° C.-60° C. | | | | |
| Stearamide | 21.00 | 10.50 | 10.50 | 12.00 |
| (Z)-docos-13-enamide | | | 10.50 | 9.00 |
| Mixture of waxes of montan acid esters | | 10.50 | | |
| (C24-C34) | | | | |
| Ethoxylated alcohol having a melting | 10-20 | 10-20 | 10-20 | 10-20 |
| point lower than 20° C. | | | | |
| Modified polyglycol ether having a | 15-25 | 15-25 | 15-25 | 15-25 |
| melting point higher than 20° C. | | | | |
| Fragrance | 1.50 | 1.50 | 1.50 | 1.50 |

The following formulation, as shown in Table 2, was prepared in order to determine its ability to deliver an end-of-life indication. This formulation was prepared by mixing the ingredients at a temperature of between 60° C. and 100° C. to obtain a flowable mixture and pouring the mixture into a plastic cage and allow it to solidify at a temperature of about 20° C. The weight of the mixture that was cast was 40 g.

The cage had one side without apertures and one side with circular apertures, so that the total open surface area of the side with apertures is 26.21 cm², of a total area of 41.1 cm². Thanks to the apertures in the cage it was possible to determine the end-of-life of the formulations.

TABLE 2
Formulation with a matrix comprising a water-soluble synthetic
polymer having a melting point higher than 150° C.

| | Formulation |
|---|---|
| Ingredient | (wt. %) F5 |
| Polyethylene glycol with melting point 55° C.-60° C. | 40-45 |
| Partially hydrolysed Poly (vinyl alcohol) having a | 40.00 |
| melting point 180° C.-190° C. | |
| Ethoxylated alcohol having a melting point lower than | 5-15 |
| 20° C. | |
| Modified polyglycol ether having a melting point higher | 5-15 |
| than 20° C. | |
| Fragrance | 0.70 |

The following formulation, as shown in Table 3, was prepared by mixing the ingredients at a temperature of between 60° C. and 100° C. to obtain a flowable mixture and pouring the mixture into a mould and allow it to solidify at a temperature of about 20° C.; at the end the solidified mixture in the form of a solid block was removed from the mould, i.e. it was a solid bock without a cage.

TABLE 3
Formulations with a matrix comprising a fatty acid amide
having a melting point higher than 85° C. without a cage.

| | Formulation |
|---|---|
| Ingredient | (wt. %) F6 |
| Polyethylene glycol with melting point 55° C.-60° C. | 40-45 |
| Stearamide | 20.00 |
| Mixture of waxes of montan acid esters (C24-C34) | 10.00 |
| Ethoxylated alcohol having a melting point lower than | 5-15 |
| 20° C. | |
| Modified polyglycol ether having a melting point higher | 10-20 |
| than 20° C. | |
| Fragrance | 0.70 |

The formulation shown in Table 4 was attached to a porous solid support by melting the formulation and dipping and extracting the substrate into the formulation several times.

Subsequently the product comprising the porous solid support and the formulation was allowed to cool down and to solidify. The solid substrate consisted of a polyester mesh having an average pore size of 1.2 mm and a dimension of 30 cm×30 cm. This polyester mesh was wrinkled into a spherical form before starting the dipping and extracting into the melted formulation. The total weight of the formulation attached to the porous solid support was 106.58 g and the diameter was approximately 6 cm.

TABLE 4
Formulations with a matrix comprising a fatty acid amide having a
melting point higher than 85° C. attached to a porous solid support.

| | Formulation |
|---|---|
| Ingredient | (wt. %) F7 |
| Polyethylene glycol with melting point 55° C.-60° C. | 40-50 |
| Stearamide | 8.40 |
| Mixture of waxes of montan acid esters (C24-C34) | 10-15 |
| Ethoxylated alcohol having a melting point lower than | 10-20 |
| 20° C. | |
| Modified polyglycol ether having a melting point higher | 15-25 |
| than 20° C. | |
| Fragrance | 0.70 |

Three formulations, as shown in Table 5, were prepared by mixing the ingredients at a temperature of between 60° C. and 100° C. to obtain a flowable mixture and pouring the mixture into a plastic cage and allow it to solidify at a temperature of about 20° C. The formulations, as shown in Table 5, were prepared in order to determine their drying performance and/or shining performance when combined with an automatic dishwashing detergent.

TABLE 5
Formulations with a matrix comprising a fatty acid amide having a
melting point higher than 85° C. and different non-ionic surfactants.

| | Formulations (wt. %) | | |
|---|---|---|---|
| Ingredient | F1 | F8 | F9 |
| Polyethylene glycol with melting point | 40-45 | 40-45 | 40-45 |
| 55° C.-60° C. | | | |
| Stearamide | 21.00 | 21.00 | 21.00 |
| Ethoxylated alcohol having a melting | 10-20 | 10-20 | |
| point lower than 20° C. | | | |
| Modified polyglycol ether-Dehypon E127 | 15-25 | | 10-20 |
| Modified polyqlycol ether-Genapol EC50 | | 15-25 | 15-25 |
| Fragrance | 1.50 | 1.50 | 1.50 |

The formulation shown in Table 6 was prepared by mixing the ingredients at a temperature of between 60° C. and 100° C. to obtain a flowable mixture and pouring the mixture into a plastic cage and allow it to solidify at a temperature of about 20° C. The formulation, as shown in Table 6, was prepared for demonstrating the ability of the formulation to increase the bleach performance of a detergent composition.

TABLE 6
Formulations with a matrix comprising a fatty acid amide having
a melting point higher than 85° C. and an oxidation catalyst.

| | Formulation |
|---|---|
| Ingredient | (wt. %) F10 |
| Polyethylene glycol with melting point 55° C.-60° C. | 40-45 |
| Stearamide | 11.10 |
| Mixture of waxes of montan acid esters (C24-C34) | 9.90 |
| Ethoxylated alcohol having a melting point lower | 10-20 |
| than 20° C. | |
| Modified polyglycol ether having a melting point | 15-25 |
| higher than 20° C. | |
| MnTACN | 0.63 |
| Fragrance | 0.70 |

The formulations shown in table 7 were prepared by mixing the ingredients at a temperature of between 60° C. and 100° C. to obtain a flowable mixture and pouring the mixture into a plastic cage and allow it to solidify at a temperature of about 20° C. The formulations, as shown in Table 7, was prepared for demonstrating the ability of the formulations to inhibit corrosion of non-metallic materials, e.g. glass, during an automatic washing operation.

TABLE 7
Formulations with a matrix comprising a fatty acid amide having
a melting point higher than 85° C. and an anti-corrosion agent.

| | Formulation (wt. %) | |
|---|---|---|
| Ingredient | F11 | F12 |
| Polyethylene glycol with melting point | 10-15 | 10-15 |
| 55° C.-60° C. | | |
| Stearamide | 5-10 | 5-10 |
| Mixture of waxes of montan acid esters | 10-15 | 10-15 |
| (C24-C34) | | |
| Ethoxylated alcohol having a melting | 10-20 | 10-20 |
| point lower than 20° C. | | |
| Modified polyglycol ether having a | 20-25 | 20-25 |
| melting point higher than 20° C. | | |
| Polyquaternium-2 | 0 | 1.50 |
| Zinc sulphate monohydrate | 25 | 0 |
| Bismuth citrate | 5 | 0 |
| Fragrance | 0.7 | 0.7 |

All formulations comply with REACH regulations in the EU.

Performance Tests

The end-of-life indication of the different formulations as shown in Table 1, are given by the %RA. Tests were performed by running washing cycles according to the following protocol in an ADW machine charged with a full load of clean ballast dishes:

Machine: General Electrics GE PDTBSSSIOSS

Programme: Normal+Heated dry function

Water hardness: 120 ppm

Samples in the cage were placed in the ADW machine and 5 cycles were run per week, leaving at least 4 hours between cycles. After each series of 5 cycles, samples were weighed and measured. The procedure was repeated after one week and tests ended either when the wax disappeared completely from a sample, or when it became apparent that the sample would not yield a clear indication of the product's progression through its lifespan.

The %RA was calculated at the beginning, after 5 cycles, after 10 cycles, after 15 cycles, after 20 cycles and after 25 cycles.

TABLE 8
End-of-life indication of formulations with a matrix comprising
a fatty acid amide having a melting point higher than 85° C.

| | % RA after cycles: | | | | | |
|---|---|---|---|---|---|---|
| Formulation | 0 | 5 | 10 | 15 | 20 | 25 |
| F1 | 100 | 100 | 100 | 100 | 100 | 100 |
| F2 | 100 | 77 | 71 | 65 | 32 | 2.5 |
| F3 | 100 | 8 | 0 | 0 | 0 | 0 |
| F4 | 100 | 74 | 45 | 39 | 36 | 33 |

Table 8 shows that compositions comprising a fatty acid amide having a melting point higher than 85° C., e.g. Stearamide, and a hydrocarbon compound having a melting point lower than 90° C., e.g. (Z)-Docos-13-enamide or mixture of waxes of montan acid esters (C24-C34), show a clear end-of-life.

It should be noted that all formulations F1-F4 gave a controlled release of the actives, more specifically, of the non-ionic surfactants aiding with the drying performance. With other words, formulation F1 does not give an end-of-life indication, but it certainly provides a controlled release of the active, although the matrix does not disappear.

The end-of-life indication of the formulation shown in Table 2, is given by weighing the solid composition after each cycle. Tests were performed by running washing cycles according to the following protocol in an empty ADW machine:

Machine: EU Bosch SMS46

Programme: Eco 50° cycle

Water hardness: 21° dH

Formulation F5 was placed in the lower rack of the ADW machine and 5 cycles were run. After each cycle, the formulation was weighed. The weight of the formulation after each cycle is shown in Table 9.

TABLE 9
End-of-life indication of formulations with a matrix
comprising a water-soluble synthetic polymer having
a melting point higher than 150° C.

| | Weight (g) after cycle | | | | | |
|---|---|---|---|---|---|---|
| Formulation | 0 | 1 | 2 | 3 | 4 | 5 |
| F5 | 40.59 | 29.29 | 22.95 | 19.60 | 18.43 | 16.17 |

Table 9 shows that a composition comprising a water-soluble synthetic polymer having a melting point higher than 150° C., e.g. Poly(vinyl alcohol), provides a controlled release of the actives and also provides a clear end-of-life indication.

The end-of-life indication of the formulation shown in Table 3, is given by weighing the solid composition after each cycle. Tests were performed by running washing cycles according to the following protocol in an empty ADW machine:

Machine: EU Bosch SMS46

Programme: Eco 50° cycle

Water hardness: 21° dH

Formulation F6 was placed in the upper rack of the ADW machine and 5 cycles were run. After each cycle, the formulation was weighed. The weight of the formulation after each cycle is shown in Table 10.

TABLE 10
End-of-life indication of formulations with a matrix
comprising a water-soluble synthetic polymer having
a melting point higher than 150° C. without a cage.

| | Weight (g) after cycle | | | | | |
|---|---|---|---|---|---|---|
| Formulation | 0 | 1 | 2 | 3 | 4 | 5 |
| F6 | 285.34 | 282.27 | 280.13 | 279.23 | 277.98 | 275.72 |

Table 10 shows that a composition comprising a fatty acid amide having a melting point higher than 85° C., e.g. Stearamide, and a hydrocarbon compound having a melting point lower than 90° C., e.g. mixture of waxes of montan acid esters (C24-C34), would show a clear end-of-life.

It should be noted that formulation F6 gave a controlled release of the actives, more specifically, of the non-ionic surfactants aiding with the drying performance. The person skilled in the art will understand that, the number of cycles in which the formulation can be used, can be controlled by reducing the initial size of the block.

The end-of-life indication of the formulation shown in Table 4, is given by weighing the formulation attached to the porous solid support after each cycle. Tests were performed by running washing cycles according to the following protocol in an ADW machine charged with a full load of clean ballast dishes:

Machine: Miele GSL 2

Programme: P3/8 min

Water hardness: 21° dH

Conventional ADW detergent was added to the dosing chamber of the dishwasher before each cycle. After each run, the front door was opened and the machine was cooled down for 1,5 hours before the solid formulation was weighed, and the next cycle was started.

Formulation F7 attached to the porous solid support was placed in the upper rack of the ADW machine and 11 cycles were run. After each cycle, the formulation attached to the porous solid support was weighed. The weight of the formulation attached to the porous solid support after each cycle is shown in Table 11.

TABLE 11
End-of-life indication of formulations with a matrix
comprising a fatty acid amide having a melting point
higher than 85° C. attached to a porous solid support.

| | Weight (g) after cycle | | | | | |
|---|---|---|---|---|---|---|
| Formulation | 0 | 1 | 2 | 3 | 4 | 5 |
| F7 | 106.58 | 103.23 | 92.88 | 78.99 | 67.61 | 60.86 |

| | Weight (g) after cycle | | | | | |
|---|---|---|---|---|---|---|
| Formulation | 6 | 7 | 8 | 9 | 10 | 11 |
| F7 | 51.78 | 47.94 | 43.39 | 36.98 | 33.27 | 23.16 |

Table 11 shows that a composition comprising a fatty acid amide having a melting point higher than 85° C., e.g. Stearamide, and a hydrocarbon compound having a melting point lower than 90° C., e.g. mixture of waxes of montan acid esters (C24-C34), shows a clear end-of-life. This is demonstrated because after 11 cycles, no residues of the formulation are observed on the porous solid support. The total mass loss over 11 cycles is 83.42 g, and the average mass loss is 7.6 g/cycle.

It should be noted that formulation F6 gave a controlled release of the actives, more specifically, of the non-ionic surfactants aiding with the drying performance. The person skilled in the art will understand that, the number of cycles in which the formulation can be used, can be controlled by modifying the size of the porous solid support and/or by adjusting the amount of solid composition that that is attached to said substrate.

The drying performance of detergents and/or rinse aids was evaluated by:
a. dosing the detergent in an automatic dishwashing machine,
b. selecting the washing protocol as mentioned below and
c. performing the test without ballast soil.

Once the program ends, the door of the dishwasher remains closed for 30 minutes. To evaluate the items, a lamp (400-Watt halogen light or an adequate energy safe lamp) must be installed on top of the dishwasher.

Evaluation

After the 30-minute waiting period, the door is fully opened. The items are then evaluated in the following order:

1. Lower test rack.

2. Cutlery basket.

3. Upper test rack.

Each item is taken out of the machine and evaluated. The drying performance is evaluated by visual inspection giving each item a Score “S” of 0, 1 or 2.

Finally, the Drying index “DI” was calculated.

Washing Protocol

Machine: General Electrics GE PDTBSSSIOSS

Programme: Normal+Power Dry

Water hardness: 120 ppm

Detergent/Test product: Cascade Action Pacs

Test Load

A lower test rack was loaded with the following items:
Porcelain: 3 dinner plates, 5 small bowls, 6 bread plates, 1 serving platter, 2 serving bowls:
Glass: 1 casserole.

A cutlery basket was loaded with the following items:
Cutlery: 8 salad forks, 8 dinner forks, 16 tea spoons, 8 knives.

An upper test rack was loaded with the following items:
Porcelain: 8 cups, 6 saucers.
Glass: 6 glasses.
Plastic: 5 plates, 3 spoons, 2 cups, 4 beaker, 1 box — rectangle, 1 box lid — rectangle, 1 box — round, 1 box lid — round, 1 box — square, 1 box lid — square, and 1 measuring cup.

All items were undamaged and without scratches.

Results—Drying Performance

The drying performance was determined by calculating the drying index “DI” of the formulations mentioned in Table 5, considering a batch of kitchenware as a whole and considering only the plastic items of said batch of kitchenware.

TABLE 12
Drying performance of formulations with a matrix
comprising a fatty acid amide having a melting
point higher than 85 ° C. comprising non-ionic surfactants.

| | Drying Index | Drying Index |
|---|---|---|
| | (DI) whole | (DI) of only |
| Formulation | kitchenware | plastic items |
| Detergent alone | 0.19 | 0.06 |
| Detergent + Rinse | 0.63 | 0.33 |
| aid | | |
| F1 | 0.73 | 0.37 |
| F8 | 0.78 | 0.51 |
| F9 | 0.72 | 0.43 |

In Table 12, rinse aid refers to a commercially available Finish rinse aid. From table 12 it can be seen that solid rinse-aid formulations comprising at least one modified polyglycol ether has an improved drying performance. The drying performance is further improved if the composition comprises at least one modified polyglycol ethers and at least one alkoxylated alcohol (e.g. ethoxylated alcohol).

Bleach Performance

The bleach performance of a detergent and the combination of a detergent and a composition according to the invention was evaluated using four teacups with bleachable stains. This evaluation was done visually by two trained evaluators.

Washing Protocol

Machine: Miele GSL 2

Program: P2/8 min

Water hardness: 21° dH

Detergent: commercially available Finish All in One Max w/o manganese-based bleach catalyst (MnTACN).

The ADW detergent was dosed at the bottom of the dishwashing machine sieve prior to every cycle. The same solid rinse aid block, i.e. formulation F10, was used for all bleach boost runs performed.

After every run the machine front door was opened and the tea cups were retrieved for evaluation. The machine was cooled down for one hour before the next cycle was started.

A comparative test was done using only the automatic dishwashing detergent, for which the bleach score was 1.7.

Results—Bleach Boost

The ability of the composition according to the invention to provide a bleach boost was determined by calculating the bleach score of a combination of a detergent and the formulation shown in Table 6, considering four cups with bleachable stains. The same solid formulation was used during 10 cycles and the bleaching scores after the cycles is shown in table 13.

TABLE 13
Bleaching performance of formulations with a
matrix comprising a fatty acid amide having a melting
point higher than 85° C. comprising an oxidation catalyst.

| | Bleach score, cycle: | | | | |
|---|---|---|---|---|---|
| Example | 1 | 2 | 3 | 5 | 10 |
| Detergent + | 10.00 | 8.00 | 8.50 | 9.75 | 9.65 |
| F10 | | | | | |

From table 13 it can be seen that solid rinse-aid formulations comprising an oxidation catalyst provide an improved bleaching performance, as the average bleach score of all runs with the ADW detergent plus solid rinse aid is 9,2 which is a significant difference to the ADW detergent alone. Furthermore, the same formulation shows a controlled release of the oxidation catalyst.

Anti-Corrosion Performance

The ability of the compositions according to the invention to controllably release an anti-corrosion agent, more specifically of the formulations shown in Table 7, is determined by using the formulations during 20 successive automatic dishwashing cycles. Tests were performed by running washing cycles according to the following protocol in an ADW machine charged with a full load of clean ballast dishes:

Machine: Miele G 1222 SC GSL

Program: 65° C.

Water hardness: <1° dH

Conventional ADW detergent (Finish 0%) was added to the dosing chamber of the dishwasher before each cycle.

Formulations F11 and F12 were tested on glass items and items with a decoration (decor items).

Test Load

Glasses:
2 glass Schott Zwiesel Mondial Burgunder 7500/0
2 glass Spiegelau Cognacglas Willsberger
2 glass Stölzle Wasserglas 2050011
2 glass Arcoroc Elegance 37249
2 glass Böckling Fiori 14cl
2 glass Pasabahce Banquet 44445
2 glass Spiegelau Sektglas Authentis 4408007

Décor Items:
2 décor glass Luminarc Coca Cola Mix Goblet FH30
2 décor glass Böckling Dekor: Amsterdam
2 décor glass Ritzenhoff+Breker Becher Conic 330 Dek. Latte Macchiato
1 décor plate Ritzenhoff+Breker Heidi 045222
1 décor cup Böckling Ceramic Decor: Amsterdam
1 décor cup pos Ceramic Decor: Monster High

Results—Anti-Corrosion

Glass corrosion of the 14 glasses and decor damages of the nine glasses was evaluated optically by a trained person. The overall scores considering glass clouding, cord lines, decoration damages and mass loss after 20 washing cycles, for formulations F11 and F12 together with an automatic dishwashing detergent, and only for an automatic dishwashing detergent are given in Table 14. The scale used for glass clouding, cord lines, and decoration damages is the following: 5 if no surface modifications are observed, 4 if minor surface modifications or hardly visible modifications are observed, 3 if visible modifications are observed, 2 if strong surface modifications are observed, and 1 if very strong surface modifications or clearly visible modifications are observed.

Mass loss in this case is given by weighing an item (glass or decor item) before and after 20 washing cycles.

TABLE 14
Anti-corrosion performance of formulations
with a matrix comprising a fatty acid
amide having a melting point higher than
85° C. comprising an anti-corrosion agent.

| | | | | Overall |
|---|---|---|---|---|
| | Glass | Cord | Decoration | mass |
| Example | clouding | lines | Damages | loss (g) |
| Detergent | 1.8 | 3.5 | 1.9 | 385 |
| Detergent + | 2.6 | 4.0 | 3.6 | 172 |
| F11 | | | | |
| Detergent + | 2.5 | 4.1 | 2.5 | 90.0 |
| F12 | | | | |

Table 14 shows that a composition comprising a fatty acid amide having a melting point higher than 85° C., e.g. Stearamide, and an anti-corrosion agent, provides for a material protection for non-metallic items, as the mass loss is greatly reduced compared to an automatic dishwashing operation in which only a detergent is used. It is further shown that better results are obtained when the anti-corrosion agent comprises or consists of a polyquaternium-2.

Hence one or more objects of the present invention are achieved by the present which is further elucidated in the appended claims.

1. A solid composition comprising a matrix and one or more actives, said matrix comprising:
stearamide or poly(vinyl alcohol) having a melting point higher than 150° C.; and
between 10 wt. % and 50 wt. % of polyethylene glycol having a melting point between 40° C. and 70° C., based on the total weight of the composition,
with the proviso that if stearamide is comprised in the matrix, the matrix further comprises at least one hydrocarbon compound having a melting point lower than 90° C. selected from the group consisting of non-glyceride long-chain (C24-C34) carboxylic acid esters, free long-chain organic acids, long-chain alcohols, (Z)-docos-13-enamide, and combinations thereof

2. The solid composition according to claim 1, wherein the composition comprises between 1 wt. % and 50 wt. % of the stearamide, based on the total weight of the composition, preferably between 5 wt. % and 40 wt. %, more preferably between 5 wt. % and 30 wt. %.

3. The solid composition according to claim 1, wherein the composition comprises between 1 wt. % and 70 wt. % of poly(vinyl alcohol) having a melting point higher than 150° C., based on the total weight of the composition, preferably between 5 wt. % and 60 wt. %, more preferably between 10 wt. % and 50 wt. %.

4. The solid composition according to claim 1, wherein the at least one hydrocarbon compound having a melting point lower than 90° C. comprises non-glyceride long-chain (C24-C34) carboxylic acid esters and/or (Z)-docos-13-enamide.

5. The solid composition according to claim 4, wherein the composition comprises between 1 wt. % and 50 wt. % of the hydrocarbon compound having a melting point lower than 90° C., based on the total weight of the composition, preferably between 1 wt. % and 30 wt. %, more preferably between 1 wt. % and 20 wt. %.

6. The solid according to claim 1, wherein the one or more actives comprise at least one non-ionic surfactant having a melting point higher than 20° C., preferably at least one modified polyglycol ether having a melting point higher than 20° C. and preferably described by the formula R¹O[CH₂CH(CH₃)O]ₓ[CH₂CH₂O]_{y}[CH₂CH(OH)R²];
wherein: R¹ represents a linear or branched chain aliphatic hydrocarbon group with 6-16 carbon atoms or mixtures thereof; R² represents a linear or branched chain aliphatic hydrocarbon rest with 6-16 carbon atoms or mixtures thereof; x has a value between 0 and 5, preferably x is 0;
and y has a value between 15 to 40, preferably between 18 to 25.

7. The solid composition according to claim 1, wherein the one or more actives comprise at least one non-ionic surfactant having a melting point lower than 20° C., preferably at least one alkoxylated alcohol having a melting point lower than 20° C. and described by the formula R³[CH₂CH₂O]_{w}OH;
wherein: R³ represents a linear or branched chain aliphatic hydrocarbon group with 10-18 carbon atoms or mixtures thereof, preferably with 12-16 carbon atoms or mixtures thereof; and w has a value between 1 and 10, preferably between 3 and 9, more preferably between 5 and 8, even more preferably 7 or 8, most preferably 8.

8. The solid composition according to claim 1, wherein the one or more actives comprise:
at least one oxidation catalyst, preferably selected from the group consisting of manganese salts, manganese proteinates, cobalt-amine catalysts, bis (N,N′,N″-trimethyl 1,4,7-triazacyclononane)-tri-(μ-oxo)-dimanganese (IV) di(hexafluorophosphate)monohydrate (MnTACN) catalyst, and combinations thereof; and/or
one or more enzymes; and/or
one or more builders; and/or
one or more anti-corrosion agents; and/or
one or more additives with antimicrobial activity selected from the group consisting of preservatives, antimicrobial bleaching agents, probiotic bacteria, metal and metal-oxide nanoparticles, and combinations thereof; and/or
at least one fragrance.

9. The solid composition according to claim 1, wherein the composition comprises between 1 wt. % and 70 wt. % of the one or more actives, based on the total weight of the composition, preferably between 1 wt. % and 60 wt. %, more preferably between 1 wt. % and 50 wt. %, even more preferably between 1 wt. % and 45 wt. %.

10. The solid composition according to claim 1, wherein the composition is an automatic dishwashing composition.

11. A cage for the release of a composition comprising one or more actives, the cage comprising at least one side with perforations, wherein in the at least one side with perforations, the ratio of the total area of the perforations to the total area without perforations of the at least one side with perforations, Aₒₚₑₙ:A_{closed}, is less than 3:1.

12. The cage according to claim 11, wherein liquid throughput per unit open area is less than 1 mL/(min×cm²), preferably less than 0.5 mL/(min×cm²), more preferably less 0.4 mL/(min×cm²)

13. A product comprising the solid composition according to claim 1 and a cage wherein the solid composition is contained in the cage,
wherein the cage comprises at least one side with perforations, wherein in the at least one side with perforations, the ratio of the total area of the perforations to the total area without perforations of the at least one side with perforations, Aₒₚₑₙ:A_{closed}, is less than 3:1.

14. A product comprising the solid composition according to claim 1 and a porous solid support, wherein the solid composition is attached to the porous solid support.

15. A method for the controlled release of one or more actives in an automatic washing operation by providing a composition according to claim 1 to a machine in which the automatic washing operation is performed; wherein preferably the automatic washing operation is an automatic dishwashing operation or a laundry washing operation, more preferably an automatic dishwashing operation.

16. (canceled)
